(19) United States
(12) Patent Application Publication
(10) Pub. No.: US 2015/0218491 A1
(43) Pub. Date: Aug. 6, 2015

(54) Use Of Polyesters In Washing And Cleaning Agents

(71) Applicant: Clariant Finance (BVI) Limited, Tortola (VG)

(72) Inventors: Roman Morschhaeuser, Mainz (DE); Dirk Fischer, Klein-Winternheim (DE); Peter Naumann, Taunusstein (DE)

(73) Assignee: Clariant Finance (BVI) Limited, Tortola (VG)

(21) Appl. No.: 14/421,970

(22) PCT Filed: Aug. 14, 2013
(86) PCT No.: PCT/EP2013/002453

§ 371 Date: Feb. 16, 2015

(30) Foreign Application Priority Data
Aug. 18, 2012 (DE) 10 2012 016 462.9

(51) Int. Cl. C11D 3/37; C11D 3/00; C08G 63/672

(52) U.S. Cl. CPC C11D 3/3715; C08G 63/672; C11D 3/0036

(57) ABSTRACT

The present invention relates to the use in washing and cleaning agents of one or a plurality of polyesters which can be obtained by polymerisation of a) terephthalic acid dimethyl ester, and b) ethylene glycol, and c) 1,2-propylene glycol, and d) one or a plurality of polyethylene glycols with mass-average molecular weights in the range from 1000 to 2000 g/mol, and e) a methyl polyethylene glycol with a mass-average molecular weight in the range from 1050 to 1350 g/mol, f) either in the presence of or in the absence of one or a plurality of cross-linking compounds with 3 to 6 polycondensation-capable functions. The polyesters are particularly suited for use in the washing and cleaning agents as dispersants or as soil release polymers.

This invention concerns the use of polyesters comprising units derived from dimethyl terephthalate, ethylene glycol, propylene glycol, polyethylene glycol, polyethylene glycol monomethyl ether (or methyl polyethylene glycol) and optionally crosslinking structural units, which for example have advantageous dispersing power or soil release properties, in washing and cleaning compositions, and also washing and cleaning compositions comprising these polyesters.

The polyesters are also highly compatible both toxicologically and ecotoxicologically.

Polyesters formed from aromatic dicarboxylic acids, such as terephthalic acid or isophthalic acid, and diols such as alkylene glycol are well known and in particular the use thereof as soil release polymers (SRPs) in washing and cleaning compositions has already been described.

DE 10 2008 023 803 describes additives for laundry detergent and cleaning compositions obtained by polycondensing an aromatic dicarboxylic acid and/or C₁-C₄-alkyl esters thereof with ethylene glycol, optionally 1,2-propylene glycol, optionally polyethylene glycol having an average molar mass of 200 to 8000 g/mol, optionally C₁-C₄-alkyl polyalkylene glycol ethers having an average molar mass of 200 to 5000 for the polyalkylene glycol ether and optionally a polyfunctional compound, and extols for example their solid consistency and hydrolysis stability. Explicitly disclosed polyesters are prepared using, for example, polyethylene glycol 6000 and a mixture of methyl polyethylene glycol 750 and methyl polyethylene glycol 2000.

DE 198 26 356 describes oligoesters obtained by polycondensing dicarboxylic acids or esters, ethylene glycol and/or propylene glycol, polyethylene glycol, a water-soluble addition product of an alkylene oxide onto C₁-C₂₄ alcohols and one or more polyols having 3 to 6 hydroxyl groups and used for example as soil release polymers in laundry detergents. Polyesters explicitly disclosed are obtained, for example, from dimethyl terephthalate, ethylene glycol, 1,2-propylene glycol, polyethylene glycol 1500, a mixture of methyl polyethylene glycol 750 and methyl polyethylene glycol 1820 and pentaerythritol.

It has now been found that, surprisingly, polyesters obtainable by polymerization of
a) dimethyl terephthalate, and
b) ethylene glycol, and
c) 1,2-propylene glycol, and
d) one or more polyethylene glycols, preferably one polyethylene glycol, having weight-average molecular weights in the range from 1000 to 2000 g/mol, and
e) one methyl polyethylene glycol having a weight-average molecular weight in the range from 1050 to 1350 g/mol
f) in the presence or absence of one or more crosslinking compounds having 3 to 6 functions capable of polycondensation, especially acid, alcohol or ester functions,
   are very useful in laundry detergent and cleaning compositions and have a very advantageous dispersing power and very advantageous soil release properties.

The present invention accordingly provides the use of one or more polyesters obtainable by polymerization of
a) dimethyl terephthalate, and
b) ethylene glycol, and
c) 1,2-propylene glycol, and
d) one or more polyethylene glycols, preferably one polyethylene glycol, having weight-average molecular weights in the range from 1000 to 2000 g/mol, and
e) one methyl polyethylene glycol having a weight-average molecular weight in the range from 1050 to 1350 g/mol
f) in the presence or absence of one or more crosslinking compounds having 3 to 6 functions capable of polycondensation, especially acid, alcohol or ester functions,
   in laundry detergent and cleaning compositions.

The polyesters used in the use of the present invention are termed “polyesters A” hereinbelow.

The polyesters A are obtainable by transesterification and condensation of components a) to e) in the presence or absence of component f) in the presence of transesterification and condensation catalysts of the prior art, such as, preferably, titanium tetraisopropoxide/sodium acetate, dibutyltin oxide, or alkali metal or alkaline earth metal alkoxides.

The polyesters A are notable for not containing residual monomers selected from polyethylene glycols and methyl polyethylene glycols having weight-average molecular weights below 1000 g/mol, which are toxicologically and ecotoxicologically undesirable.

It is an essential feature of the present invention that a single methyl polyethylene glycol having a weight-average molecular weight in the range from 1050 to 1350 g/mol is used as monomer and not a mixture of two or more methyl polyethylene glycols. This provides polyesters A of narrower molecular weight distribution and improved quality.

Preference for use as component d) is given to one or more compounds selected from polyethylene glycols having weight-average molecular weights in the range from 1200 to 1800 g/mol.

It is particularly preferable to use one polyethylene glycol having a weight-average molecular weight of 1500 g/mol as component d).

It is preferable for component e) to be one methyl polyethylene glycol having a weight-average molecular weight in the range from 1100 to 1300 g/mol.

It is particularly preferable for component e) to be one methyl polyethylene glycol having a weight-average molecular weight of 1250 g/mol.

In one preferred embodiment of the invention, the polyesters A are obtainable by polymerization of components a) to e) in the presence of component f).

Preference for use as component f) is given to compounds selected from the group consisting of citric acid, malic acid, tartaric acid, gallic acid, 2,2-dihydroxymethylpropionic acid, pentaerythritol, glycerol, sorbitol, mannitol, 1,2,3-hexanetriol, benzene-1,2,3-tricarboxylic acid (hemimellitic acid), benzene-1,2,4-tricarboxylic acid (trimellitic acid) and benzene-1,3,5-tricarboxylic acid (trimesic acid).

Compounds selected from the group consisting of pentaerythritol and glycerol are particularly preferred for use as component f).

Pentaerythritol is greatly preferred for use as component f).

In one further preferred embodiment of the invention, the polyesters A are obtainable by polymerization of components a) to e) in the absence of component f).

Preference is given to polyesters A obtainable by polymerization of components a) to e) in the presence or absence of component in the following molar ratios, each based on 1 mol of component a):

0.2 to 0.8 mol, preferably 0.3 to 0.7 mol, more preferably 0.4 to 0.6 mol and most preferably 0.5 to 0.6 mol of component b), and
1.0 to 2.0 mol, preferably 1.1 to 1.6 mol, more preferably 1.2 to 1.5 mol and most preferably 1.3 to 1.4 mol of component c), and
0.05 to 2.0 mol, preferably 0.1 to 1.0 mol, more preferably 0.2 to 0.8 mol and most preferably 0.25 to 0.5 mol of component d), and
0.01 to 1.0 mol, preferably 0.05 to 0.8 mol, more preferably 0.1 to 0.5 mol and most preferably 0.11 to 0.3 mol of component e), and
in the presence of 0.00001 to 1.0 mol, preferably 0.00001 to 0.5 mol, more preferably 0.0001 to 0.01 mol and most preferably 0.0002 to 0.01 mol, of component f) or in the absence of component f).

The polyesters A preferably have weight-average molecular weights in the range from 700 to 50 000 g/mol, more preferably in the range from 800 to 25 000 g/mol, even more preferably in the range from 1000 to 15 000 g/mol and yet more preferably in the range from 1200 to 12 000 g/mol. Weight-average molecular weight is determined by size exclusion chromatography in aqueous solution by using a calibration with narrowly distributed sodium polyacrylate as standard.

The polyesters A are preferably obtained by polymerizing components a) to e) in the presence or absence of component f).

The polyesters A are preferably nonionic polyesters.

In one particularly preferred embodiment of the invention, the polyesters A are obtainable by polymerization of components a) to e) in the presence or absence of component f), wherein the amount of component d) used in the polymerization is <80.0 wt %, preferably <70.0 wt % and more preferably <50.0 wt %, all based on the overall weight of components a) to e) or a) to f) used for the polymerization.

In a further particularly preferred embodiment of the invention, the polyesters A are obtainable by polymerization of components a) to e) in the presence or absence of component f), wherein the amount of structural units derived from component d) in the polyesters A is <80.0 wt %, preferably <70.0 wt % and more preferably <50.0 wt %, all based on the overall weight of the polyesters A.

In a further particularly preferred embodiment of the invention, the polyesters A are obtainable by polymerization of components a) to e) in the presence or absence of component f), wherein the amount of components d) and e) used for the polymerization is together <80.0 wt % and preferably <70.0 wt %, both based on the overall weight of components a) to e) or a) to f) used for the polymerization.

In a further particularly preferred embodiment of the invention, the polyesters A are obtainable by polymerization of components a) to e) in the presence or absence of component f), wherein the amount of structural units derived from components d) and e) together in the polyesters A is <80.0 wt % and preferably <70.0 wt %, both based on the overall weight of the polyesters A.

As mentioned, the polyesters A are notable for advantageous dispersing power. They are also notable for an advantageous soil-releasing and soil-repelling effect, in particular with regard to oily and fatty stains, and are advantageous soil release polymers.

In one preferred embodiment of the invention, the one or more polyesters A are used in the washing and cleaning compositions as dispersants.

In a further preferred embodiment of the invention, the one or more polyesters A are used in the washing and cleaning compositions as soil release polymers.

The present invention also provides washing and cleaning compositions comprising one or more polyesters A. These washing and cleaning compositions comprise the one or more polyesters A in an amount of preferably 0.01 to 10.0 wt %, based on the overall weight of the final washing and cleaning compositions.

The washing and cleaning compositions may include the usual further ingredients known to a person skilled in the art.

Washing compositions for the purposes of the present invention are in particular washing compositions for cleaning and reconditioning textiles.

In the case of washing compositions of this type, as with the washing compositions of the present invention, for example, the ingredients are, for example, anionic, nonionic, amphoteric and cationic surfactants, bleaching agents, bleach activators, bleaching catalysts, builders, co-builders, detergent alkalis, enzymes, sequestrants, further soil release polymers, grayness inhibitors, dye transfer inhibitors, color-fixing agents, complexing agents, optical brighteners, softening components, dyes, scents, emulsifiers, hydrotropes, organic solvents, and also water.

Cleaning compositions for the purposes of the present invention are in particular cleaning compositions for cleaning dishes and for cleaning hard surfaces such as, for example, of tiles, floors, etc.

In the case of cleaning compositions of this type, as with the cleaning compositions of the present invention, for example, the ingredients are, for example, anionic, nonionic, amphoteric and cationic surfactants, bleaching agents, bleach activators, bleaching catalysts, builders, co-builders, alkalis, enzymes, sequestrants, further soil release polymers, complexing agents, dyes, scents, emulsifiers, hydrotropes, organic solvents, acids, in particular organic acids, disinfectants, thickeners, preservatives, pearl luster agents, glass corrosion inhibitors, silver corrosion inhibitors, foam regulators and also water.

Polyesters A are used with particular preference in cleaning compositions.

Polyesters A also form a further part of the subject matter of the present invention.

The one or more polyesters A are preferably used in the form of aqueous dispersions, for example incorporated as an aqueous dispersion into the washing and cleaning compositions. The one or more polyesters A, however, may also be incorporated into the washing and cleaning compositions as such. The use of an aqueous dispersion has the advantage of easier meterability and improved handleability over the use of the polyesters as such.

The present invention accordingly also provides aqueous dispersions comprising one or more polyesters A.

The aqueous dispersions comprise the one or more polyesters A in an amount of preferably 5.0 to 50.0 wt %, more preferably 10.0 to 30.0 wt % and still more preferably 15.0 to 25.0 wt %, all based on the overall weight of the final aqueous dispersion. In one particularly preferred embodiment of the invention, the aqueous dispersions consist of the one or more polyesters A and water.

The polyesters A are notable for an advantageous dispersibility and solubility in water. Aqueous dispersions consisting of the polyesters A and water have advantageous stability in storage and exhibit little if any sedimenting.

The example which follows is provided for further elucidation, but not limitation of the invention. Unless explicitly stated otherwise, all percentages are by weight (wt %).

### EXAMPLE 1

### Polyester 1

A 1-L four-neck flask equipped with KPG stirrer, internal thermometer, Vigreux column, distillation bridge, N₂ supply (5 l/h) and Anschütz-Thiele adapter was initially charged with 164.4 g (0.85 mol) of dimethyl terephthalate, 87.9 g (1.155 mol) of 1,2-propanediol, 29.5 g (0.475 mol) of ethylene glycol, 1.14 g (0.008 mol) of pentaerythritol and 0.75 g (0.0009 mol) of sodium acetate and the reaction mixture was subsequently heated up to 60° C. internal temperature under N₂ blanketing (5 l/h), with stirring at a stirrer speed of 50-100 rpm. The N₂ line was closed and then 0.2 g (0.0007 mol) of titanium tetraisopropoxide was added. Stirrer speed was subsequently raised to 300 rpm and the batch was heated up to an internal temperature of 150° C. in the course of 2 h and to an internal temperature of 200° C. in the course of a further 2 h. The N₂ line was reopened at an internal temperature of 170° C. The reaction mixture was heated at 200° C. for 2 h and the methanol formed was distilled off and condensed in an ice-cooled receiver. The reaction mixture was subsequently cooled down to room temperature and 328.7 g (0.219 mol) of polyethylene glycol 1500 and 137.8 g (0.11 mol) of polyethylene glycol monomethyl ether 1250 were added. The mixture was heated up to 215° C. internal temperature under N₂ blanketing (5 l/h) with stirring at a stirrer speed of 300 rpm, the N₂ line was closed and the pressure was reduced to 150 mbar in the course of 2 h and to 10 mbar in the course of a further 2 h while glycol was distilled off. After supplementary condensation at 215° C. and 10 mbar for 2 h the melt was cooled down to 140-150° C. The system was then vented with N₂ and the hot melt was discharged. A solidified beige polymer melt was obtained.

1. A washing and cleaning composition comprising at least one polyester prepared by polymerization of
a) dimethyl terephthalate, and
b) ethylene glycol, and
c) 1,2-propylene glycol, and
d) at least one polyethylene glycol having a weight-average molecular weight in the range from 1000 to 2000 g/mol, and
e) one methyl polyethylene glycol having a weight-average molecular weight in the range from 1050 to 1350 g/mol
f) in the presence or absence of one or more crosslinking compounds having 3 to 6 functions capable of polycondensation.

2. The washing and cleaning composition as claimed in claim 1 wherein the at least one polyester is prepared by polymerization using at least one polyethylene glycol having a weight-average molecular weight in the range from 1000 to 2000 g/mol.

3. The washing and cleaning composition as claimed in claim 1, wherein at least one polyethylene glycol having weight-average molecular weights in the range from 1200 to 1800 g/mol are used in the polymerization as component d).

4. The washing and cleaning composition as claimed in claim 1, wherein at least one polyethylene glycol having a weight-average molecular weight of 1500 g/mol is used in the polymerization as component d).

5. The washing and cleaning composition as claimed in claim 1, wherein one methyl polyethylene glycol having a weight-average molecular weight in the range from 1100 to 1300 g/mol is used in the polymerization as component e).

6. The washing and cleaning composition as claimed in claim 5 wherein one methyl polyethylene glycol having a weight-average molecular weight of 1250 g/mol is used in the polymerization as component e).

7. The washing and cleaning composition as claimed in claim 1, wherein the at least one polyester is prepared by polymerization of components a) to e) in the presence of component f).

8. The washing and cleaning composition as claimed in claim 7 wherein at least one compound selected from the group consisting of citric acid, malic acid, tartaric acid, gallic acid, 2,2-dihydroxymethylpropionic acid, pentaerythritol, glycerol, sorbitol, mannitol, 1,2,3-hexanetriol, benzene-1,2,3-tricarboxylic acid (hemimellitic acid), benzene-1,2,4-tricarboxylic acid (trimellitic acid) and benzene-1,3,5-tricarboxylic acid (trimesic acid) are used in the polymerization as component f).

9. The washing and cleaning composition as claimed in claim 1, wherein the at least one polyester is prepared by polymerization of components a) to e) in the following molar ratios, each based on 1 mol of component a):
0.2 to 0.8 mol of component b), and
1.0 to 2.0 mol of component c), and
0.05 to 2.0 mol of component d), and
0.01 to 1.0 mol of component e),
in the presence of 0.0 to 1.0 mol of component f).

10. The washing and cleaning composition as claimed in claim 9 wherein the at least one polyester is prepared by polymerization of components a) to e) in the following molar ratios, each based on 1 mol of component a):
0.3 to 0.7 mol of component b), and
1.1 to 1.6 mol of component c), and
0.1 to 1.0 mol of component d), and
0.05 to 0.8 mol of component e),
in the presence of 0.0 to 0.5 mol of component f).

11. The washing and cleaning composition as claimed in claim 10 wherein the at least one polyester is prepared by polymerization of components a) to e) in the following molar ratios, each based on 1 mol of component a):
0.4 to 0.6 mol of component b), and
1.2 to 1.5 mol of component c), and
0.2 to 0.8 mol of component d), and
0.1 to 0.5 mol of component e),
in the presence of 0.0 to 0.01 mol of component f).

12. The washing and cleaning composition as claimed in claim 1, wherein the at least one polyester has a weight-average molecular weight in the range from 700 to 50 000 g/mol.

13. The washing and cleaning composition as claimed in claim 12 wherein the at least one polyester has a weight-average molecular weight in the range from 1000 to 15 000 g/mol.

14. A dispersant comprising at least one polyester prepared by polymerization of
a) dimethyl terephthalate, and
b) ethylene glycol, and
c) 1,2-propylene glycol, and
d) at least one polyethylene glycol having a weight-average molecular weight in the range from 1000 to 2000 g/mol, and
e) one methyl polyethylene glycol having a weight-average molecular weight in the range from 1050 to 1350 g/mol
f) in the presence or absence of one or more crosslinking compounds having 3 to 6 functions capable of polycondensation.

15. A soil release polymer comprising at least one polyester prepared by polymerization of
a) dimethyl terephthalate, and
b) ethylene glycol, and
c) 1,2-propylene glycol, and
d) at least one polyethylene glycol having a weight-average molecular weight in the range from 1000 to 2000 g/mol, and
e) one methyl polyethylene glycol having a weight-average molecular weight in the range from 1050 to 1350 g/mol
f) in the presence or absence of one or more crosslinking compounds having 3 to 6 functions capable of polycondensation.

16. A process for washing and cleaning a hard surface comprising the steps of applying at least one washing and cleaning composition as claimed in claim 1 to the hard surface and subsequently removing the washing and cleaning composition.

17. A process for washing and cleaning dishes comprising the steps of applying at least one washing and cleaning composition as claimed in claim 1 to the dishes and subsequently removing the washing and cleaning composition.

18. A process for washing and cleaning textiles comprising the steps of applying at least one washing and cleaning composition as claimed in claim 1 to the textiles and subsequently removing the washing and cleaning composition.
